(19) United States
(12) Patent Application Publication
(10) Pub. No.: US 2023/0364857 A1
(43) Pub. Date: Nov. 16, 2023

(54) ADDITIVE MANUFACTURING METHOD FOR CONTINUOUSLY PRODUCING MOLDED BODIES, AND CORRESPONDING APPARATUS

(71) Applicant: Siemens Aktiengesellschaft, 80333 München (DE)

(72) Inventors: Karsten Heuser, Erlangen (DE); JULIAN ANDREAS WALDMANN, Oberhaching (DE)

(73) Assignee: Siemens Aktiengesellschaft, 80333 München (DE)

(21) Appl. No.: 18/022,038

(22) PCT Filed: Aug. 3, 2021
(86) PCT No.: PCT/EP2021/071633

§ 371 Date: Feb. 17, 2023

(30) Foreign Application Priority Data
Aug. 21, 2020 (EP) 20192167.3

(51) Int. Cl. B29C 64/153; B33Y 30/00; B33Y 10/00; B33Y 40/20; B29B 17/00; B29C 64/188; B29C 64/245; B29C 64/371; B29C 64/30

(52) U.S. Cl. CPC B29C 64/153; B33Y 30/00; B33Y 10/00; B33Y 40/20; B29B 17/0005; B29C 64/188; B29C 64/245; B29C 64/371; B29C 64/30

(57) ABSTRACT

Apparatus for continuously producing a molded body by an additive manufacturing method includes a processing region receiving a powder applied layer-by-layer to form a molded body, and a separation device having a separation element which can be introduced into the processing region to form chambers in the processing region. The separation device further includes a drive to move the separation element such as to lower the chambers in a vertical direction during the layer-by-layer processing from a treatment portion of the processing region to a removal portion of the processing region, and to remove the separation element in the removal portion of the processing region at least in part from the processing region for opening a lower one of the chambers so that the molded body is able to fall or slide out of the processing region.

The invention relates to an additive manufacturing method enabling the continuous production of molded bodies, as well as to a corresponding apparatus. In particular, the invention relates to production by means of selective laser sintering or by means of binder jetting methods.

### PRIOR ART

Additive manufacturing methods for producing molded bodies, i.e. three-dimensional structures or workpieces, include selective laser sintering and binder jetting methods. Laser sintering comprises three main process steps for this purpose. In the first step, the system used for the selective laser sintering is prepared by introducing a build chamber into the opened system. The build chamber is then flooded with a shielding gas. The actual laser printing process is performed in a second step in which the workpiece is built up layer by layer in a layered structure. To that end, a powdered starting material is irradiated by means of a laser, resulting in a sintering process. This enables any desired three-dimensional structures to be produced. The build chamber is removed in a third step. The printed components are located in the powder-filled build chamber and must be removed from the build chamber and cleaned. For this purpose, the depowdering can be carried out manually in a second chamber using a vacuum cleaner.

Of the three described process steps, only the second step, i.e. the actual laser sintering, is a value-adding stage, while process steps 1 and 3 serve only for the pre- and postprocessing phases. In addition, a human workforce is required for performing the first and third process steps. This results in the produced components becoming more expensive and the productivity of the machines used is generally low.

It is therefore an object of the invention to make the overall process for producing molded bodies by means of additive manufacturing methods more efficient.

### SUMMARY OF THE INVENTION

The invention provides an apparatus allowing the continuous production of molded bodies by means of additive manufacturing methods and a corresponding additive manufacturing method having the features recited in the independent claims.

Advantageous embodiments are the subject matter of the dependent claims.

According to a first aspect, the invention accordingly provides an apparatus for the continuous production of molded bodies by means of an additive manufacturing method. The apparatus comprises a processing region and a separation device. The processing region is embodied to receive a powder, wherein a layer-by-layer processing of at least part of the powder in order to form molded bodies can be performed in the processing region by means of the additive manufacturing method. The separation device comprises at least one separation element which can be or is introduced into the processing region in such a way that chambers are formed in the processing region. The separation device has a drive which is embodied to move the at least one separation element in such a way that the chambers are lowered in the vertical direction during the layer-by-layer processing from a treatment portion of the processing region to a removal portion of the processing region. In addition, the drive moves the at least one separation element in such a way that the at least one separation element in the removal portion of the processing region is removed at least in part from the processing region in such a way that a lower of the chambers is opened so that the produced molded bodies fall or slide out of the processing region.

According to a second aspect, the invention provides an additive manufacturing method allowing the continuous production of molded bodies, wherein at least part of a powder introduced into a processing region in order to produce the molded bodies is processed layer by layer by means of the additive manufacturing method. At least one separation element has been or is introduced into the processing region in such a way that chambers are formed in the processing region. The at least one separation element is moved in such a way that the chambers are lowered in the vertical direction during the layer-by-layer processing from a treatment portion of the processing region to a removal portion of the processing region. In addition, the at least one separation element is moved in such a way that the at least one separation element in the removal portion of the processing region is removed at least in part from the processing region in such a way that a lower of the chambers is opened so that the produced molded bodies fall or slide out of the processing region.

The apparatus is characterized in that provision is made for the continuous production of molded bodies by means of an additive manufacturing method. Accordingly, the apparatus is operated continuously rather than for performing batch processes. There is no need to open the apparatus and introduce a build chamber into the opened system. In particular, it is also not necessary to flood the build chamber with fresh shielding gas after each printing operation. The apparatus for the continuous production of molded bodies by means of the additive manufacturing method is preferably prepared once initially and subsequently can be operated without need for further manual interventions. Thanks to the continuous operation, the laser printing process can be performed considerably more quickly and more efficiently. Productivity is significantly improved and the method is made more cost-effective.

A further advantage is that as a result of the continuous processing, no manual interaction is necessary after the completion of one molded body in order to produce a further molded body. Due to the long processing time, this is of particular advantage since, for example in the case of processing operations which are completed at night without an operator being present, processing of a further molded body can be continued immediately without an unnecessary no-load cycle.

Furthermore, it is also possible for a single operator to control and monitor a plurality of such apparatuses for the continuous production of molded bodies without difficulty.

According to one embodiment of the apparatus for the continuous production of molded bodies by means of the additive manufacturing method, the apparatus is connected via an interface to a control device by way of which an operator can control the apparatus by means of remote access. The apparatus operates continuously such that no manual interaction is required following the completion of a production process (apart from a cleaning operation, if necessary) in order to start a further production process. This enables the apparatus to be controlled by way of a remote access without an operator needing to be present on site.

According to one embodiment of the apparatus for the continuous production of molded bodies by means of the additive manufacturing method, the apparatus is arranged vertically. By this is to be understood that the processing region is divided into chambers in the vertical direction by means of the separation element. The components are produced at an upper end of the processing region, for example by irradiation during layer-by-layer laser sintering or by solidification during binder jetting. At the lower end, the finished molded bodies are provided, i.e. they fall or slide out of the processing region.

According to one embodiment, the apparatus for the continuous production of molded bodies by means of the additive manufacturing method comprises a receiving device which is embodied to receive molded bodies that have fallen or slid out of the processing region. For example, the receiving device can be a tray which can be removed from the apparatus in order to extract the molded bodies and pass them on for further processing. The receiving device can preferably be removed separately so that it is not necessary to open the entire apparatus. In particular, a shielding gas remains in the region between the laser device and the treatment portion of the processing region.

According to one embodiment of the apparatus for the continuous production of molded bodies by means of the additive manufacturing method, the receiving device comprises a conveyor element for transporting received molded bodies away from the processing region. The continuous operation of the apparatus for producing molded bodies is improved further as a result. Thus, it can even be provided that a manual interaction between users and the apparatus itself is not necessary. The user is required simply to extract the molded bodies provided by means of the conveyor element. Opening the apparatus or elements of the apparatus is no longer necessary.

According to one embodiment, the apparatus for the continuous production of molded bodies by means of the additive manufacturing method comprises a postprocessing device which is embodied for postprocessing the molded bodies transported by means of the conveyor element. This enables the postprocessing also to be performed fully automatically and the requisite manual interventions are reduced further.

According to one embodiment of the apparatus for the continuous production of molded bodies by means of the additive manufacturing method, the postprocessing device is embodied to process the molded bodies by means of one of the following methods:
treating the molded bodies by means of a sandblasting method,
polishing the molded bodies,
grinding the molded bodies,
tamping the molded bodies,
coating the molded bodies,
heat-treating and
coloring the molded bodies.

The molded bodies can therefore be inspected following their production using an inline technique.

According to one embodiment, the apparatus for the continuous production of molded bodies by means of the additive manufacturing method comprises a powder feeding device which is embodied to feed powder one layer at a time to the processing region. The powder feeding device is coupled to the receiving device in such a way as to feed back to the processing region at least some of the powder accumulating in the receiving device when the molded bodies fall or slide out. The remaining powder accumulating during the additive manufacturing method can thus be mixed with new powder in a closed circuit, preferably quality-checked by way of an inline inspection and reintroduced into the treatment portion of the processing region at the upper end.

According to one embodiment of the apparatus for the continuous production of molded bodies by means of the additive manufacturing method, the receiving device comprises an at least partially impermeable section, in particular a perforated metal plate, which is embodied to receive the molded bodies as they fall or slide out of the processing region. The receiving device further comprises a tray which is embodied to collect the powder that has accumulated in the receiving device and fallen through the perforated metal plate when the molded bodies fall or slide out. This enables the depowdering to be carried out without manual intervention, as a result of which no operative has to come into contact with the powder. In particular, the need for a depowdering chamber can be dispensed with completely.

According to one embodiment of the apparatus for the continuous production of molded bodies by means of the additive manufacturing method, a depowdering machine can be provided which removes remaining powder that has been left on the molded bodies after they have slid or fallen out of the processing region. The remaining powder can be removed from the molded bodies, for example by suction or by means of a blower or by compressed air. The depowdering machine can be, for example, one of the above-described postprocessing devices.

According to one embodiment of the apparatus for the continuous production of molded bodies by means of the additive manufacturing method, the processing region comprises a cooling zone which is embodied for cooling the molded bodies following production. Conventionally, the cooling is accomplished in such a way that build chambers containing finished molded bodies are parked in a hall and either no temperature check at all is performed or temperature probes are introduced manually into the chamber in order to measure the decay curve. In contrast, by using a cooling zone in the processing region in the apparatus for the continuous production of molded bodies, it can be ensured that the molded bodies always cool down under identical or similar conditions. This means that a greater reproducibility of the molded bodies can be achieved. The cooling zone can comprise a temperature controller in order to guarantee identical cooling conditions.

According to one embodiment of the apparatus for the continuous production of molded bodies by means of the additive manufacturing method, the cooling zone is embodied in such a way that the molded bodies fall or slide out of the processing region as soon as a predefined end temperature is reached. The cooling zone adjoins a build section of the processing region in which the molded bodies are produced.

According to one embodiment of the apparatus for the continuous production of molded bodies by means of the additive manufacturing method, the build section is dimensioned in such a way that a molded body is introduced into the cooling zone essentially immediately after the completion of the production in the build section. This enables the molded bodies to be provided as quickly as possible since the time during which the molded bodies are contained in the apparatus for the continuous production of molded bodies is reduced to a minimum.

According to one embodiment of the apparatus for the continuous production of molded bodies by means of the additive manufacturing method, a shielding gas is introduced in a region between the laser device and the treatment portion of the processing region. The region between the laser device and the treatment portion of the processing region is fluidically separated from the removal portion of the processing region. This prevents shielding gas from escaping and the continuous production of the molded bodies is ensured. Compared to a change of shielding gas each time a component is removed, this considerably reduces the consumption of shielding gas.

According to one embodiment of the apparatus for the continuous production of molded bodies by means of the additive manufacturing method, the separation device has a plurality of separation elements. The drive introduces the separation elements in the treatment portion of the processing region into the processing region and removes them from the processing region after the lowering in the removal portion of the processing region and conveys the separation elements back to the treatment portion of the processing region. The separation elements are thus continuously introduced into the processing region and moved downward, thereby enabling the continuous operation.

According to one embodiment of the apparatus for the continuous production of molded bodies by means of the additive manufacturing method, the separation device comprises a helix-shaped element having at least one helical turn. The at least one helical turn forms the at least one separation element. The drive rotates the helix-shaped element around an axis of rotation. This removes the need for components to be conveyed back from the lower region to the upper region. Rather, the continuous operation is made possible as a result of the rotation of the helix-shaped element. At the lower end, a corresponding device prevents the powder from sliding out completely along with the molded bodies. For instance, a closing mechanism can be provided which is operated in synchronism with the rotation of the helix-shaped element such that only the lowest molded body slides out at any time. The closing mechanism can be operated for example only when production of the uppermost molded body at any given time has been completed.

According to one embodiment, the apparatus is embodied for the continuous production of molded bodies by means of selective laser sintering. The apparatus can comprise a laser device which is embodied to emit at least one laser beam. In particular, the laser device may also comprise two lasers. In the processing region, the powder is processed at least in part to form molded bodies by means of the at least one emitted laser beam.

According to one embodiment, the apparatus is embodied for the continuous production of molded bodies by means of binder jetting methods (3D printing methods).

According to one embodiment of the additive manufacturing method, following their production, the molded parts are cooled in a cooling zone of the processing region.

According to one embodiment of the additive manufacturing method, the molded bodies are transported away from the processing region by means of a conveyor element.

The above-described characteristics, features and advantages of this invention, as well as the manner in which these are realized, will become dearer and more readily understandable in connection with the following description of the exemplary embodiments, which are explained in more detail with reference to the drawings, in which:

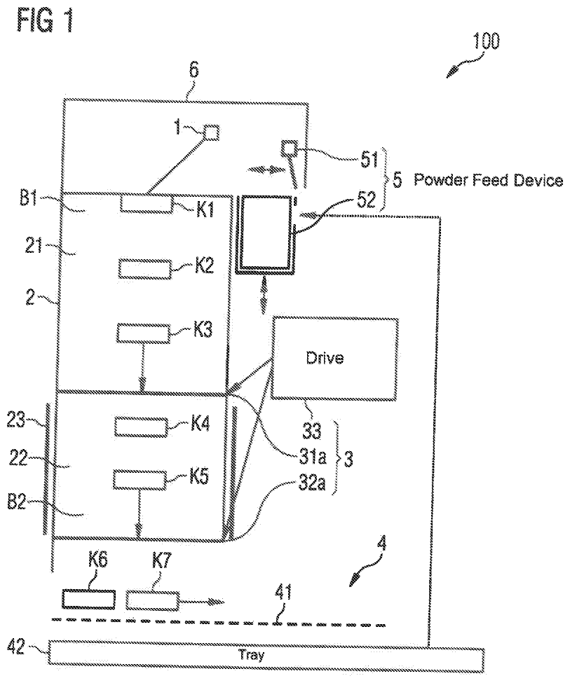

FIG. 1 shows a schematic cross-sectional view of an apparatus for the continuous production of molded bodies by means of the additive manufacturing method according to one embodiment of the invention,

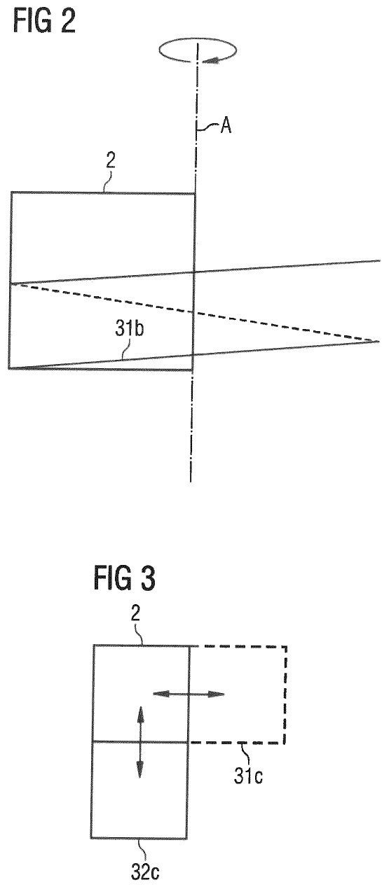

FIG. 2 shows a schematic cross-sectional view of a processing region comprising a separation device for an apparatus for the continuous production of molded bodies by means of an additive manufacturing method according to one embodiment of the invention,

FIG. 3 shows a schematic cross-sectional view of a further processing region comprising a separation device for an apparatus for the continuous production of molded bodies by means of an additive manufacturing method according to one embodiment of the invention, and

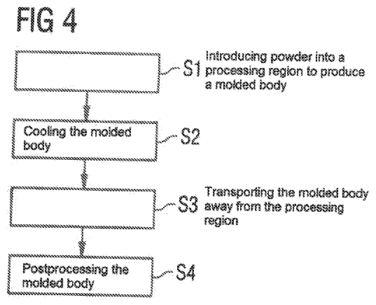

FIG. 4 shows a flowchart of an additive manufacturing method for the continuous production of molded bodies according to one embodiment of the invention.

### DETAILED DESCRIPTION OF THE FIGURES

FIG. 1 shows a schematic cross-sectional view of an apparatus 100 for the continuous production of molded bodies K1 to K7 by means of selective laser sintering, i.e. by means of an additive manufacturing method. The apparatus 100 comprises a laser device 1 which emits a laser beam. The apparatus further comprises a build chamber housing 6.

The apparatus 100 further comprises a chamber 2 which represents a processing region 2. The processing region 2 extends in the vertical direction from a treatment portion or irradiation portion B1, in which the processing of a powder takes place, to a removal portion B2 in which the molded bodies K1 to K7 are removed. The processing region 2 is filled with the powder, which is processed layer by layer by means of the emitted laser beam. Irradiating the powder causes a sintering process to take place, with the result that molded bodies K1 to K7 are produced layer by layer.

A separation device 3 comprises a drive 33 as well as separation elements 31a, 32a which are driven by means of the drive 33. The separation elements 31a, 32a form chambers 21, 22 in the processing region 2. The separation elements 31a, 32a are moved by means of the drive 33 in such a way that they are moved downward in the vertical direction to the removal portion B2. The separation elements 31a, 32a can be metal separating plates, for example, which are inserted automatically into the processing region 2 in the horizontal direction. After the separation elements 31a, 32a have been moved downward to the removal portion B2, they are moved out of the processing region 2 again in the horizontal direction. The separation elements 31a, 32a are moved by means of a mechanism that is driven by the drive 33 outside of the processing region 2 once more to the upper portion in the vicinity of the treatment portion B1 and reintroduced into the processing region 2. The separation device 3 is operated in such a way that at least one separation element 31a, 31b is contained in the processing region 2 at all times in order to form a processing chamber 21 in which the powder contained in the processing region 2 is processed by means of the laser beam.

Alternatively, it can also be provided that the separation elements 31a, 32a are introduced into the processing region 2 from above in the region of the treatment portion B1. The separation elements 31a, 32a are held and moved vertically downward by means of a vertically displaceable mechanism mounted at the side in the processing region 2. As soon as the metal separating plates 31a, 32a arrive in the removal portion B2, they are removed from below out of the processing region 2 again and transported back upward.

The drive 33 is preferably operated in discrete steps. Following each processing step, during which a layer of the powder is processed, the separation elements 31a, 32a are lowered further thereby. The apparatus 100 further comprises a powder dosing container 52 and a recoater 51, which form a powder feeding device 5. After the separation elements 31a, 32a have been lowered, powder is introduced from the powder dosing container 52 into the processing region 2 and smoothed by means of the recoater 51. As a result, a new powder layer is prepared for processing and is processed in turn by means of the laser beam. The powder dosing container 52 can likewise be moved in the vertical direction for this purpose so that new powder can be introduced.

The recoater 51 can also be embodied to smooth the powder layer once again after the insertion of the separation elements 31a, 32a. This enables irregularities in the surface of the powder which can be caused due to the insertion of the separation elements 31a, 32a to be removed again.

After the lowest separation element 31a, 32a is removed from the processing region 2, a lower chamber 22 is opened. The molded bodies K4, K5 contained therein are exposed as a result and slide out of the processing region 2 along with the powder contained in the lower chamber 22.

A shielding gas is introduced in a region between the laser device 1 and the treatment portion B1 of the processing region 2. The region between the laser device 1 and the treatment portion B1 of the processing region 2 is fluidically separated from the removal portion B2 of the processing region 2.

A receiving device 4 comprising a conveyor element 41 for receiving the molded bodies K6, K7 that have slid out of the processing region 2 is positioned below the processing region 2. The conveyor element 4 is for example a conveyor belt which transports the molded bodies K6, K7 away from the processing region 2 in the horizontal direction. The conveyor element 41 comprises a perforated metal plate and consequently has holes through which the powder falls into a tray 42 located under the conveyor element 41. The powder accumulating in the tray 42 can be supplied automatically to the powder feeding device 5. For example, the powder accumulating in the tray 42 can be introduced directly into the powder dosing container 52. Alternatively, a separate container can also be provided in order to separate powder that has already been used from the new powder. The already used powder can be reintroduced into the processing region 2 together with the new powder.

A postprocessing device can furthermore be provided which post processes the molded bodies K6, K7. For example, the molded bodies K6, K7 can be postprocessed directly on the conveyor element 41. The molded bodies K6, K7 can be cleared of powder for example by means of a vacuum cleaner or by means of compressed air. Further processing steps can include sandblasting methods, polishing methods, grinding methods, tamping methods, coating methods, heat treatment methods, and/or coloring methods.

Also provided is a cooling zone 23 which cools a lower section of the processing region 2. The cooling zone 23 comprises cooling elements which can also be integrated into the processing region 2. In the cooling zone 23, the finished molded bodies K4, K5 are cooled down to a predefined end temperature. The cooling zone 23 is preferably dimensioned in such a way that the molded bodies K1 to K7 fall or slide out from the processing region 2 shortly after reaching the end temperature (for example within minutes of reaching the end temperature). This prevents the molded bodies K1 to K7 from remaining in the processing region 2 for longer than necessary.

The Invention is not limited to the embodiment shown. In particular, depending on application case, an appropriately chosen number of molded bodies K1 to K7 can be contained in the apparatus 100 at the same time. Furthermore, an arbitrarily chosen number of separation elements 31a, 32a can be provided.

Moreover, the apparatus can also be embodied for producing molded bodies by means of other additive manufacturing methods, in particular by means of binder jetting methods. For this purpose, the powdered starting material can be adhesively bonded at predefined points by means of a binder. The rest of the construction of the apparatus 100 can correspond to the embodiment shown in FIG. 1.

FIG. 2 shows a schematic cross-sectional view of a processing region 2 having a separation device for an apparatus for the continuous production of molded bodies K1 to K7 by means of an additive manufacturing method. In this case the separation device comprises a helix-shaped element 31b having at least one helical turn. The at least one helical turn 31b forms the at least one separation element. The drive incrementally rotates the helix-shaped element around an axis of rotation A after each processing step. This causes the molded bodies K1 to K7 to be conveyed downward. A closing mechanism (not shown) is also provided in order to ensure that only at least one of the fully finished molded bodies slides out at any given time.

FIG. 3 shows a schematic cross-sectional view of a further processing region 2 having a separation device for an apparatus for the continuous production of molded bodies by means of an additive manufacturing method. In this case separation elements 31c, 32c can be introduced into the processing region 2 from two different sides.

FIG. 4 shows a flowchart of an additive manufacturing method for the continuous production of molded bodies K1 to K7, in particular by means of selective laser sintering or binder jetting.

In a first method step S1, a powder is introduced into a processing region 2 for the purpose of producing the molded bodies K1 to K7. The powder is processed layer by layer by means of the additive manufacturing method. In this case at least one separation element is or has been introduced into the processing region 2 in such a way that chambers 21, 22 are or have been formed in the processing region 2. The at least one separation element is moved in the vertical direction such that the chambers 21, 22 are lowered in the vertical direction during the layer-by-layer processing from a treatment portion B1 of the processing region 2 to a removal portion B2 of the processing region 2. The at least one separation element in the removal portion B2 of the processing region 2 is removed at least in part from the processing region 2 in such a way that a lower of the chambers 21, 22 is opened so that the produced molded bodies K1 to K7 fall or slide out of the processing region 2.

In a second method step S2, following their production, the molded bodies K1 to K7 are cooled in a cooling zone 23 of the processing region 2.

In a third method step S3, the molded bodies K1 to K7 are transported away from the processing region 2 by means of a conveyor element 41.

In a fourth method step S4, a further postprocessing of the molded bodies K1 to K7 takes place, for example by means of sandblasting methods, polishing methods, grinding methods, tamping methods, coating methods, heat treatment methods, and/or coloring methods. Further, the molded bodies K1 to K7 can additionally be depowdered.

Although the invention has been illustrated and described in greater detail on the basis of the preferred exemplary embodiments, the invention is not limited by the disclosed examples and other variations may be derived herefrom by the person skilled in the art without leaving the scope of protection of the invention.

1.-15. (canceled)

16. Apparatus for continuously producing a molded body by an additive manufacturing method, said apparatus comprising:
a processing region receiving a powder and configured to allow execution of a layer-by-layer processing of at least part of the powder to form a molded body by the additive manufacturing method; and
a separation device comprising a separation element introducible into the processing region to form chambers in the processing region, and a drive designed to move the separation element such as to lower the chambers in a vertical direction during the layer-by-layer processing from a treatment portion of the processing region to a removal portion of the processing region, and to remove the separation element in the removal portion of the processing region at least in part from the processing region for opening a lower one of the chambers so that the molded body is able to fall or slide out of the processing region.

17. The apparatus of claim 16, further comprising a receiving device designed to receive the molded body fallen or slid out of the processing region.

18. The apparatus of claim 17, wherein the receiving device comprises a conveyor element in order to transport the molded body away from the processing region.

19. The apparatus of claim 18, further comprising a postprocessing device designed to post process the molded body transported by the conveyor element.

20. The apparatus of claim 19, wherein the postprocessing device is designed to treat the molded body by at least one process selected from the group consisting of sandblasting, polishing, grinding, tamping, coating, heat treatment, and coloring.

21. The apparatus of claim 17, further comprising a powder feeding device designed to feed the powder layer by layer to the processing region, said powder feeding device being coupled to the receiving device so as to allow powder that has accumulated in the receiving device as the molded body falls or slides out to be fed back to the processing region.

22. The apparatus of claim 17, wherein the receiving device comprises a perforated metal plate designed to receive the molded body that has fallen or slid out of the processing region, and a tray designed to receive powder that has accumulated in the receiving device and fallen through the perforated metal plate when the molded body falls or slides out.

23. The apparatus of claim 16, wherein the processing region comprises a cooling zone designed to cool the molded body.

24. The apparatus of claim 23, wherein the cooling zone is designed in such a way that the molded body falls or slides out of the processing region as soon as the molded body reached a predefined end temperature.

25. The apparatus of claim 16, further comprising:
a laser device for executing the additive manufacturing method; and
shielding gas introduced in a region between the laser device and the treatment portion of the processing region, said region between the laser device and the treatment portion of the processing region being fluidically separated from the removal portion of the processing region.

26. The apparatus of claim 16, wherein the separation device comprises a plurality of said separation element, said drive designed to introduce the separation elements in the treatment portion of the processing region to the processing region, to remove the separation elements from the processing region after being lowered in the removal portion of the processing region, and to convey separation elements back to the treatment portion of the processing region.

27. The apparatus of claim 16, wherein the separation device comprises a helix-shaped element having at least one helical turn to form the separation element, said drive designed to rotate the helix-shaped element around an axis of rotation.

28. The apparatus of claim 16, wherein the additive manufacturing method is a process selected from the group consisting of selective laser sintering and binder jetting.

29. An additive manufacturing method for continuously producing a molded body, said method comprising:
introducing powder into a processing region to produce a molded body layer by layer;
inserting a separation element into the processing region to form chambers in the processing region; and
moving the separation element such as to lower the chambers in a vertical direction during the layer-by-layer processing from a treatment portion of the processing region to a removal portion of the processing region, and to remove the separation element in the removal portion of the processing region at least in part from the processing region for opening a lower one of the chambers so that the molded body is able to fall or slide out of the processing region.

30. The method of claim 29, further comprising cooling the molded body in a cooling zone of the processing region.
